(19) United States
(12) Patent Application Publication
(10) Pub. No.: US 2004/0121218 A1
(43) Pub. Date: Jun. 24, 2004

(54) Fuel cell water management

(76) Inventor: Craig Andrews, College Station, TX (US)

Correspondence Address: STREETS & STEELE, 13831 NORTHWEST FREEWAY, SUITE 355, HOUSTON, TX, 77040, US

(21) Appl. No.: 10/732,891

(22) Filed: Dec. 9, 2003

Related U.S. Application Data
(60) Provisional application No. 60/432,313, filed on Dec. 9, 2002.

(51) Int. Cl. H01M 8/04

(52) U.S. Cl. 429/38; 429/25; 429/22; 429/13

(57) ABSTRACT

The present invention provides a method and apparatus for managing water within a fuel cell. The method and apparatus include supplying a reactant gas stream at a flow rate that exceeds the rate of reactant consumption within the fuel cell by an amount that results in a sufficiently high velocity through the fuel cell to remove excess product water from an electrode of the fuel cell. The method and apparatus may be utilized regarding any reactant gas stream, including an oxidant gas stream, a fuel gas stream, or both. The oxidant gas stream is preferably an oxygen-containing stream, such as air, oxygen, or a combination thereof. The fuel gas stream is preferably hydrogen gas, regardless of whether the hydrogen gas is provided electrolytically or from a partial oxidation of a hydrocarbon.

This application claims priority from U.S. Provisional Application No. 60/432,313, filed Dec. 9, 2002.

### BACKGROUND OF THE INVENTION

1. Field of the Invention

The present invention relates to gas and water management for a fuel cell system.

2. Background of the Related Art

A fuel cell is an electrochemical device that produces electrical energy using a fuel and an oxidant. The fuel is supplied to an anode and the oxidant is supplied to the cathode. At the anode, the fuel gives up protons and electrons. The electrons pass through an external circuit to the cathode, thereby providing an electrical current that can be utilized by a load device, such as a motor. The protons pass through a proton exchange membrane that forms a gas barrier, but conducts protons to the cathode. At the cathode, the protons and electrons combine with the oxidant to form a product. For example, a hydrogen-oxygen/air fuel cell consumes hydrogen at the anode and produces water at the cathode.

In Proton Exchange Membrane (PEM) fuel cells, in order for the membrane to have a high ionic conductivity, the membrane must be well hydrated. While the membrane material is easily wetted, maintaining hydration of the membrane is complicated by the fact that water is drawn through the membrane from the anode to the cathode by electro-osmosis (otherwise referred to as electroosmotic drag) at a rate proportional to the current density. A further factor that complicates hydration is that the fuel gas may be provided to the anode in a relatively dry condition unless a separate humidification process has been performed. Likewise, dry oxidant is provided to the cathode unless a separate humidification process is performed. When oxygen from the air is used as the oxidant feed, the volume of dry gas passing into the fuel cell is increased by at least a factor of five. This increase in gas flow through the fuel cell removes significantly more water, thereby increasing humidification and water management requirements.

As stated above, a fuel-oxygen/air fuel cell will form water on the surface of the cathode during normal operation of the fuel cell. So long as there is uniform catalyst loading on the anode and cathode, open access to the surface of the anode and cathode electrocatalysts, uniform reactant gas distribution over the face of the anode and cathode, and uniform current through the active area, then the formation of water will occur more or less uniformly over the surface of the cathode. Some of this product water will back-diffuse into the membrane and, under certain operating conditions, may provide sufficient hydration, at least over portions of the membrane and/or a portion of the operating conditions.

Because the product water formed at the cathode has the potential to cover or flood the electrocatalyst surface and prevent the oxidant from reaching the electrocatalyst, it is equally important to remove surplus product water from the electrocatalyst surface as it is to hydrate the membrane. While some of the product water is carried away from the electrocatalyst surface by back-diffusion into the membrane and humidification of the reactant gas (here, the oxidant gas), much of the product water accumulates on the electrocatalyst surface as a liquid. This is a greater problem along the lower edge of the electrode, since gravity will cause the water to run downward over the face of the electrode.

Various methods exist for preventing or eliminating the buildup of product water on the cathode. One method includes the use of a cathodic gas diffusion layer that is at least partially hydrophobic. The hydrophobic surfaces repel water and maintain open pathways for the oxidant gas to access the electrocatalyst surface. While this method is helpful, it alone doesn't go far enough to prevent water accumulation. Another method includes passing gas through the cathode at a sufficiently high velocity to force or draw liquid water out of, or off of, the electrocatalyst surface and preferably out of the fuel cell altogether. This method is also helpful, but results in the loss of valuable reactant gases and water. Methods that include reactant gas recirculation require pumps to draw reactant gas from the exit of the fuel cell and deliver it back to the reactant gas supply tank or the reactant gas inlet to the fuel cell. Unfortunately, the use of recirculation pumps is limited primarily to research and development facilities, since the parasitic consumption of electrical power by the pumps results in a considerable reduction in the net power density of the fuel cell system and recirculation pumps represent considerable cost and high maintenance systems. Another method of reactant gas recirculation is the use of an eductor or venturi to use the feed reactant gas as the motive force to create a lower pressure and draw reactant gas from the exit end of the fuel cell. These systems have not proven to provide sufficient recirculation to provide adequate water management.

Therefore, there is a need for a method and apparatus that enables efficient removal of water from an electrocatalyst surface of a fuel cell. It would be desirable if the method and apparatus could remove water without interrupting the operation of the fuel cell. It would also be desirable if the method and apparatus could recover reactant gases that pass through the fuel cell without being consumed and recover water that is removed from the fuel cell, especially if the recovery could be accomplished with little or no parasitic power losses. It would be further desirable if the method and apparatus could improve the hydration of the membrane, particularly in the driest regions of the fuel cell. Still, it would be even more desirable if all this could be accomplished with a simple system that has few moving parts.

### BRIEF DESCRIPTION OF THE DRAWINGS

FIG. 1 is a schematic process flow diagram of one embodiment of the present invention during a filling or purging step.

FIG. 2 is a schematic process flow diagram of one embodiment of the present invention during a supplying step.

FIG. 3 is a schematic process flow diagram of a second embodiment of the present invention during a filling step.

FIG. 4 is a schematic process flow diagram of a second embodiment of the present invention during a supplying step.

FIG. 5 is a schematic process flow diagram of a second embodiment of the present invention during a purging step.

FIG. 6 is a graphical illustration of the change in reactant gas stoichiometry over time as the fuel cell is in operation.

FIG. 7 is a schematic process flow diagram of a third embodiment of the present invention having an accumulator in fluid communication with two reactant gas systems.

FIG. 8 is a schematic process flow diagram of a system that was operated according to one embodiment of the present invention.

FIGS. 9A-9B are graphical illustrations of the results that were obtained during an experiment using the system illustrated in FIG. 8.

### SUMMARY OF THE INVENTION

The present invention provides a method and an apparatus for managing water within a fuel cell. In one embodiment of the invention, an apparatus is provided that includes a reactant gas accumulator in fluid communication with a reactant gas manifold of a fuel cell. The apparatus may further include a reactant gas source that is in selective fluid communication with an inlet manifold of the fuel cell, wherein the inlet manifold and an outlet manifold are in fluid communication. Typically, the inlet manifold and the outlet manifold are in fluid communication across an electrode of the fuel cell.

The apparatus may further include a pressure regulator disposed between the reactant gas source and the inlet manifold. A pressure controller may be disposed between the reactant gas source and the inlet manifold, wherein the pressure controller is capable of varying the velocity of the reactant gas provided to the inlet manifold. The apparatus may further include a control valve disposed between the reactant gas source and the inlet manifold, wherein the valve may be selected, for example, from a solenoid valve, pneumatically driven valve, a pilot operated valve, and a motor driven valve. A flow control valve may be disposed between the reactant gas source and the inlet manifold to control the flow of the reactant gas.

The apparatus may further include a sensor that is capable of measuring an operating condition or parameter of the system. One such sensor may measure the pressure within the accumulator. One or more sensors may also measure the flow rate of the reactant gas through the fuel cell, measure the voltage of the fuel cell, measure the state of the fuel cell membrane hydration, measure the liquid water presence in the fuel cell, and measure the humidity of the reactant gases within the fuel cell. A pressure sensor may also be disposed within the accumulator and the apparatus may further be provided with a means for determining the rate of pressure change within the accumulator.

With a control valve disposed between the reactant gas source and the inlet manifold, the apparatus may further include a controller in communication with the control valve, wherein the controller instructs the valve to provide the selective communication. The controller may provide a duty cycle wherein the control valve is open for a first time period and the control valve is closed for a second time period. The controller may provide a duty cycle that is based on one or more operating parameters of the system.

The apparatus of one embodiment of the present invention may further include a flow restriction device disposed in fluid communication between the reactant gas accumulator and the outlet manifold. A flow restriction device may be disposed in fluid communication at a position between the reactant gas source and the inlet manifold, between the reactant gas accumulator and the outlet manifold, or a combination thereof.

The reactant gas accumulator may also be in fluid communication with an inlet manifold of the fuel cell and may further include a first check valve allowing unidirectional flow from the reactant gas accumulator to the inlet manifold and a second check valve allowing unidirectional flow from the outlet manifold to the reactant gas accumulator. There may be means for directing the reactant gas flow from the accumulator into the fuel cell in a direction selected from the same direction as the reactant gas flow from the reactant gas source into the fuel cell, the opposite direction as the reactant gas flow from the reactant gas source in the fuel cell, and combinations thereof. The apparatus may also include means for alternating the direction of reactant gas flow into the fuel cell. The apparatus may include a valving arrangement positioned in the reactant gas conduits to alternate the direction of reactant gas flow into the fuel cell, wherein the valving arrangement may be, for example, selected from a shuttle valve and a four-way flow reversing valve.

The apparatus may include a valve controller in communication with a valve for providing the selective communication between the reactant gas source and the inlet manifold, wherein the valve controller includes a timer and operates the valve at specific time periods. Also included may be a second accumulator in fluid communication with a second reactant gas, wherein one of the reactant gas accumulators has a pressure regulator referenced to the pressure of the other reactant gas.

In another embodiment, the apparatus may include a fuel cell having reactant gas distribution channels providing fluid communication between a reactant gas source and an accumulator vessel, wherein the reactant gas may be selected, for example, from a fuel gas and an oxidant gas. A pressure regulator may be disposed between the reactant gas source and the reactant gas distribution system. Further, a pressure controller may be disposed between the reactant gas source and the reactant gas distribution system, wherein the pressure controller is capable of varying the velocity of the reactant gas provided to the reactant gas distribution system.

In another embodiment, the apparatus includes an oxidant gas accumulator in fluid communication with an oxidant gas outlet manifold of a fuel cell and a fuel gas accumulator in fluid communication with a fuel gas outlet manifold of the fuel cell. The oxidant gas may comprise oxygen and the fuel gas may comprise hydrogen. The apparatus may further include a pressure regulator disposed between an oxidant gas source and an oxidant gas inlet manifold and also, a pressure regulator disposed between a fuel gas source and a fuel gas inlet manifold.

One embodiment of a method of the present invention includes the steps of purging water from a fuel cell with a reactant gas supply; accumulating the reactant gas under pressure from the reactant gas supply; and supplying the accumulated reactant gas to the fuel cell. The method may further include supplying the accumulated reactant gas to the fuel cell through an inlet manifold, an outlet manifold, or a combination thereof. The reactant gas may be selected from an oxidant gas and a fuel gas.

Additional steps of the method may include accumulating a second reactant gas under pressure from a second reactant gas supply; supplying the accumulated second reactant gas to the fuel cell, wherein the reactant gases comprise an oxidant gas and a fuel gas; and regulating the pressure of the reactant gas. The flow rate of the reactant gas from the reactant gas supply may also be regulated. Other steps may include receiving the purged water in the accumulator; and removing the purged water from the accumulator.

The method may further include the step of repeating the steps of purging, accumulating and supplying. The steps of purging, accumulating and supplying may be repeated under conditions selected from pressure within the accumulator, flow rate of the reactant gas through the fuel cell, voltage of the fuel cell, state of fuel cell membrane hydration, and combinations thereof

Another embodiment of the present invention provides a method that includes the steps of supplying a reactant gas through a fuel cell at a flow rate sufficient to remove water; and then returning the reactant gas to the fuel cell. This method may further comprise periodically switching between the steps of supplying and returning, wherein the steps are periodically switched according to a duty cycle.

### DETAILED DESCRIPTION

The present invention provides a method and apparatus for managing water within a fuel cell. The method and apparatus include supplying a reactant gas stream at a flow rate that exceeds the rate of reactant consumption within the fuel cell by an amount that results in a sufficiently high velocity through the fuel cell to remove excess product water from an electrode of the fuel cell. The method and apparatus may be utilized regarding any reactant gas stream, including an oxidant gas stream, a fuel gas stream, or both. The oxidant gas stream is preferably an oxygen-containing stream, such as air, oxygen, or a combination thereof. The fuel gas stream is preferably hydrogen gas, regardless of whether the hydrogen gas is provided electrolytically or from a partial oxidation of a hydrocarbon.

After the reactant gas passes through the fuel cell and removes water, the reactant gas and water are received in an accumulator vessel. The accumulator vessel is preferably a pressure vessel having constant volume, although the accumulator could also have a variable volume as provided by an elastic bladder or bellows.

In a preferred mode of operation, the accumulator supplies the accumulated reactant gas to the fuel cell when the reactant gas source has been shut off. In this manner, the reactant gas is not discarded, but returns to the fuel cell, as reactant gas is consumed, driven by the pressure that was established in the accumulator. Furthermore, there is continuous supply of the reactant gas to the fuel cell. In the most simple embodiment, the accumulator may be in direct fluid communication with the fuel cell at all times and there is no need for the accumulator to be separated from the fuel cell by an isolation valve.

In an optional mode of operation, the accumulator may periodically dump the accumulated reactant gas. The periodic dumping of reactant gas is only necessary or beneficial if it is determined or suspected that the reactant gas contains unacceptable concentrations of inert gases. In this context, the term “inert gases” means any gases that do not contribute to the fuel cell reactions. In a hydrogen-air/oxygen fuel cell, essentially any gas other than hydrogen and oxygen is an inert gas. Where air is used as the oxidant gas, nitrogen will be the primary inert gas. However, even in an oxygen fuel cell, the level of inert gases may build up to unacceptable levels over time. Immediately following the fill period (before the fill valve is closed and the fuel cell draws gas from the accumulator), essentially all of the inert gases will have been flushed out of the fuel cell and concentrated in the accumulator. At this time, if the concentration of inerts is unacceptable, the accumulator may be configured in a manner allowing it to be isolated and the entire contents of the accumulator removed and directed to an inert gas removal system. During these periods of isolation, the fuel cell may continue to operate with the reactant gas from the reactant gas supply dead-ended into the fuel cell.

In the system of the present invention, the fuel cell is fluidically in series between a reactant gas inlet valve and an accumulator. Periodic operation of the inlet valve and subsequent pressure fluctuations are used to create a periodic gas flow through the fuel cell. Accordingly, the accumulator operates as the primary reactant gas supply for the fuel cell. During this period of operation, the pressure in the accumulator will fall as the gas is consumed, until a given condition is reached, such as a preset pressure, and the inlet valve is opened to repressurize the accumulator. During the filling of this accumulator, the main reactant gas inlet valve is opened, allowing reactant gas to flow through the fuel cell at a high stoichiometry, effectively transferring any surplus water from the fuel cell to the accumulator. As the pressure in the accumulator approaches that of the reactant gas supply, the stoichiometry falls to a value of about one as the fuel cell consumes the reactant gas at the rate it is delivered. When a subsequent condition is reached, such as the accumulator achieving a target pressure, then the inlet valve is closed and the reactant gas is dead-ended into the fuel cell. During the initial, but brief periods of filling the accumulator, the effective stoichiometry is high but the actual gas utilization from the fuel cell remains constant as the surplus ‘tail gas’ flows into and pressurizes the accumulator. With each repetition of this sequence, surplus water is removed from the fuel cell.

A second aspect of the present invention for managing water includes providing humidified reactant gas across an electrode to improve hydration of at least certain portions of the membrane. The reactant gas accumulated in the accumulator is humidified by virtue of it having passed through the fuel cell and coming into intimate contact with the water within the fuel cell. When this accumulated reactant gas is returned to the fuel cell, the water vapor hydrates the membrane.

Liquid water that builds up within the accumulator can be drawn out of the accumulator, such as upon reaching a setpoint level. While this water may be discarded, it is preferable to utilize the water, such as by pumping the water to a water storage system. For example, when the fuel cell is a regenerative fuel cell it is possible to provide the water to the anode during an electrolyzer mode. The term “regenerative fuel cell” means that the fuel cell is capable of regenerating fuel when there is electricity available to do so. It should be recognized that the regenerative fuel cell may be a unitized regenerative fuel cell in which the fuel cell may also be operated in an electrolyzer mode. Alternatively, the regenerative fuel cell may include a separate electrolyzer and fuel cell, in which case the water is provided to the anode of the electrolyzer.

In one embodiment of the invention, the accumulator may provide the reactant gas flow to either the inlet end or the outlet end of the reactant gas manifold depending upon which region of the membrane needs the most hydration. Typically, the leading edge of the membrane in each cell will tend to dry out the most since the reactant gas supply may not be humidified. Similarly, the reactant gas supply will typically flow downward over the face of the electrodes such that gravity will tend to pull water away from the same leading edge of the membrane.

A controller may be provided to automate the gas distribution system. The controller may be used in conjunction with one or more sensors that provide information regarding the operating conditions of the system.

The system of cycling the accumulator will also allow the controller to accurately measure the rate of gas consumption. Since the volumes are known and the number of cycles is known, the only unknown is the amount of gas consumed by the fuel cell while the accumulator is being filled. However, when the accumulator is full and being drained, the rate of consumption can be determined and is quite likely very close to the fill cycle consumption. Adding another accumulator would allow the fuel cell to be operated from one or the other so at no time is there an unknown volume of gas being supplied to the fuel cell.

FIG. 1 is a schematic process flow diagram of one embodiment of the present invention during a filling or purging step. The system 10 includes a reactant gas source or supply 12 in fluid communication with an inlet 14 to a fuel cell 16 through a pressure regulator 18 and a control valve 20 operated in response to the forward pressure sensed by the pressure switch 22. The reactant gas is passed through the inlet manifold 24, across individual electrodes 26, and through the outlet manifold 28 to an accumulator 30. The accumulator 30 receives reactant gas and water from the fuel cell until the pressure in the accumulator is equal to the pressure in the fuel cell 16. Accumulated amounts of water 32 collecting in the bottom of the accumulator may be withdrawn for subsequent use.

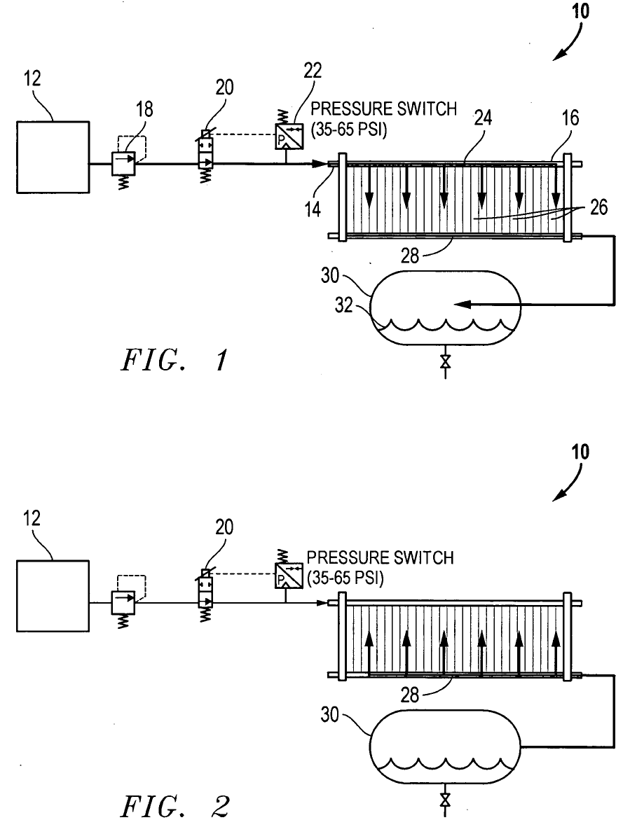

FIG. 2 is a schematic process flow diagram of one embodiment of the present invention as shown in FIG. 1 during a supplying step. After filling the accumulator 30 as shown in FIG. 1, the control valve 20 is closed. As reactant gas is consumed by the fuel cell 16, additional reactant gas flows from the accumulator into the fuel cell under the storage pressure. When the gas stoichiometry drops to one or it becomes necessary to remove water from the electrodes 26, then the control valve 20 is reopened as in FIG. 1. This cycle can be continued as needed to manage the water within the fuel cell.

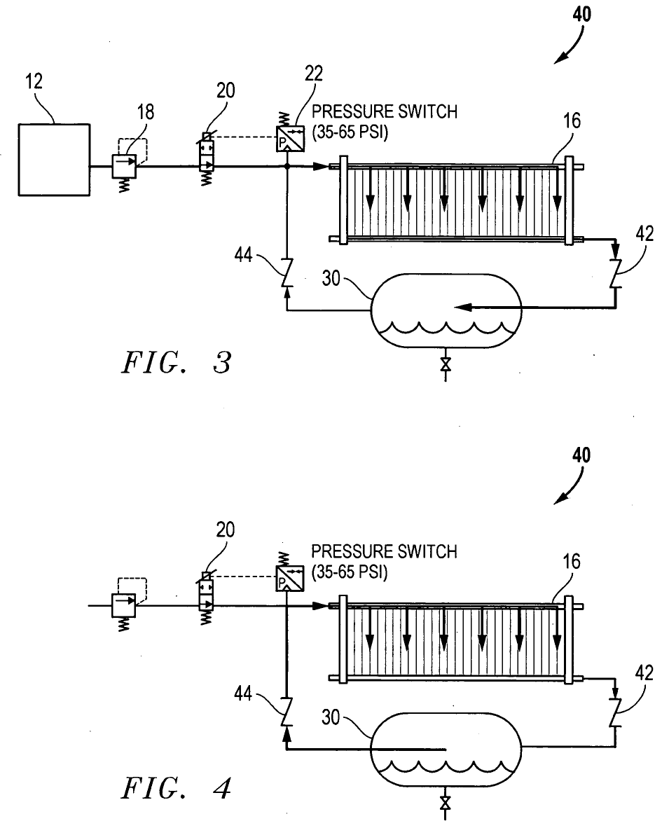

FIG. 3 is a schematic process flow diagram of a second embodiment of the present invention during a filling step. The system 40 has many of the same components as system 10 of FIGS. 1 and 2, but also includes a pair of unidirectional check valves 42 and 44 that allow flow only in the direction of the arrows shown. In FIG. 3, the control valve 20 is open and the reactant gas flows through the fuel cell 16 to the accumulator 30.

FIG. 4 is a schematic process flow diagram of a second embodiment of the present invention during a supplying step. After the accumulator 30 is full, the control valve 20 is closed and the reactant gas in the accumulator 30 supplies the fuel cell. As the gas is consumed, the gas flows under pressure from the accumulator to the fuel cell through the check valve 44. As provided in system 40, the accumulator 30 provides humidified reactant gas to the fuel cell in the same direction as the reactant gas supply 12. As discussed previously, this may be advantageous for hydrating dry regions of the membrane.

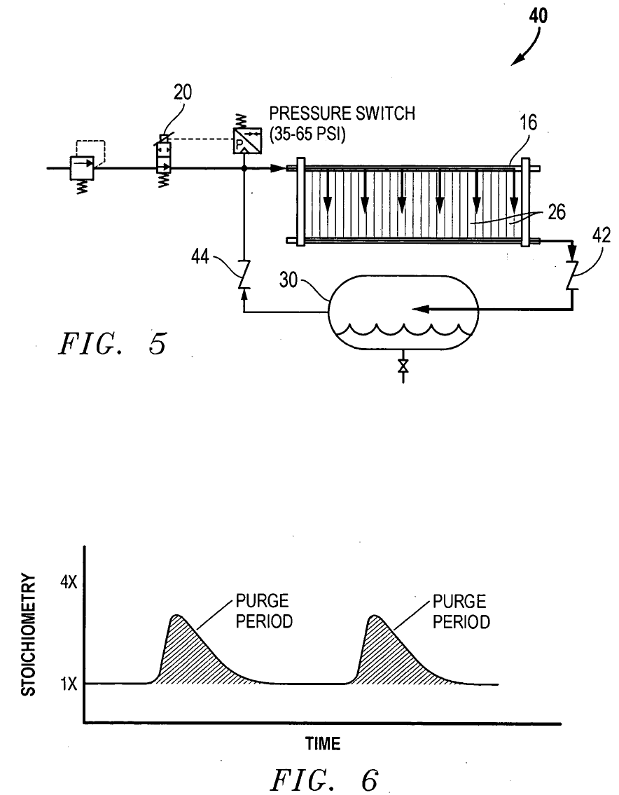

FIG. 5 is a schematic process flow diagram of a second embodiment of the present invention during a purging step. After the stoichiometry of the reactant gas declines, for example, the control valve 20 is again opened to purge water from the electrodes 26 of the fuel cell 16 into the accumulator 30. The processes of FIGS. 4 and 5 are repeated periodically or upon satisfying certain process conditions such as by monitoring the reactant gas pressure of the fuel cell.

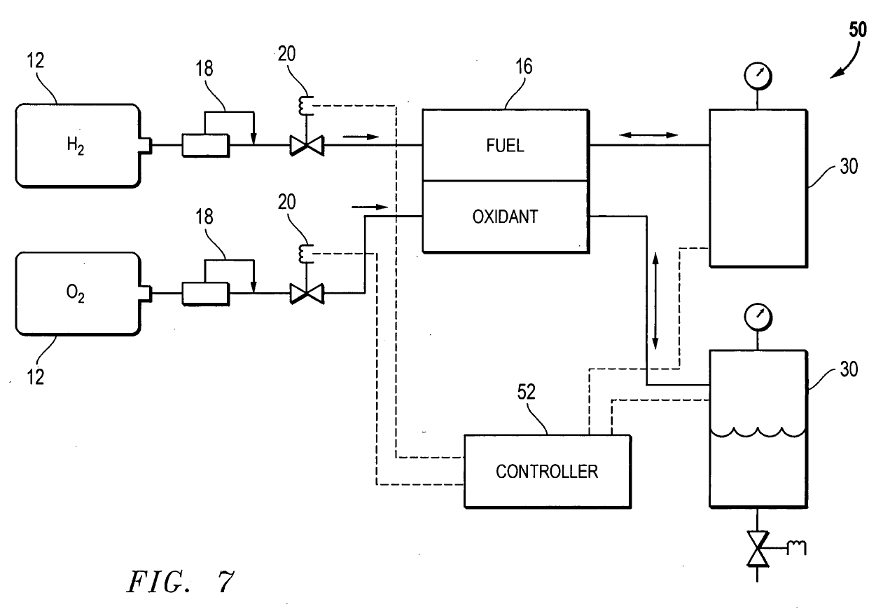

FIG. 6 is a graphical illustration of the change in reactant gas stoichiometry over time as the fuel cell is in operation. The graph shows reactant gas purge steps alternating with reactant gas supply from the accumulators.

FIG. 7 is a schematic process flow diagram of a third embodiment of the present invention having an accumulator in fluid communication with two reactant gas systems comprising the oxidant gas system and the fuel gas system to the fuel cell 16. The system 50 is essentially the combination of two systems 10 as set out in FIGS. 1 and 2. Alternatively, the system could comprise two systems 40 as set out in FIGS. 3-5. A separate controller 52 is also shown providing overall control of the system 50, both through monitoring of process conditions and sending instructions to control valves of the system.

### EXAMPLE

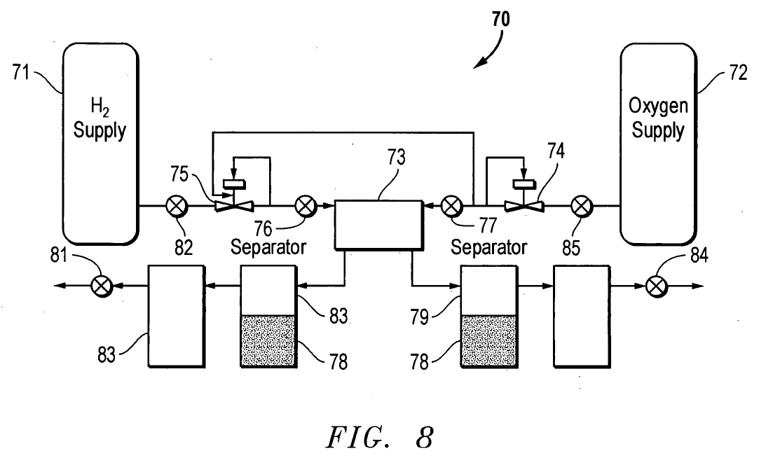

One embodiment of the present invention has been demonstrated using the system shown in FIG. 8. The system 70 included a hydrogen supply tank 71 and an oxygen supply tank 72 for supplying reactants to the fuel cell stack 73. The pressure of the oxygen flowing to the fuel cell 73 was typically controlled at about 100 psig using a pressure regulator 74 and the hydrogen pressure was typically controlled at about 100 psig using a tracking forward pressure regulator 75 referenced to the oxygen pressure. An oxygen shutdown solenoid valve 77 and a hydrogen shutdown solenoid valve 76 were used for shutting down the fuel cell stack 73 and were in the open position when the fuel cell stack 73 was in operation.

Oxygen flowed from the oxygen supply tank 72 through the fuel cell stack 73 and into the oxygen accumulator 79. Hydrogen flowed from the hydrogen supply tank 71 through the fuel cell stack 73 and into the hydrogen accumulator 83. Both the hydrogen system outlet solenoid valve 81 and the oxygen system outlet solenoid valve 84 normally remained closed and typically were opened only during a system shutdown or to periodically purge inert gases from the system 70. The accumulators 79, 83 accumulated the generated water 78 that flowed with the reactants from the fuel cell stack 73 for disposal.

During the first phase of the operation of the system 70, the fuel cell stack 73 was operated with hydrogen from the hydrogen storage tank 71 and with oxygen from the oxygen storage tank 72. The accumulators 79, 83 pressured up to the operating pressure of the fuel cell stack 73, thereby accumulating a reservoir of hydrogen in the hydrogen accumulator 83 and a reservoir of oxygen in the oxygen accumulator 79. At a preset time, which was every two minutes in this example, both the hydrogen system inlet solenoid valve 82 and the oxygen system inlet solenoid valve 85 were simultaneously closed, allowing the fuel cell stack 73 to operate on the accumulated hydrogen and oxygen that had been stored in the hydrogen accumulator 83 and the oxygen accumulator 79. During this period, reactants flowed from the accumulators 79, 83 to the fuel cell stack 73. After the pressure in the fuel cell stack 79 had dropped to about 75 psig, the oxygen and hydrogen system inlet valves 82, 85 were reopened simultaneously, causing a rapid increase in the fuel cell stack 73 pressure back to the normal 100 psig operating pressure. This rush of gases into the fuel cell stack 73 effectively removed water from the fuel cell stack 73 by pushing the water into the hydrogen and oxygen accumulators 79, 83.

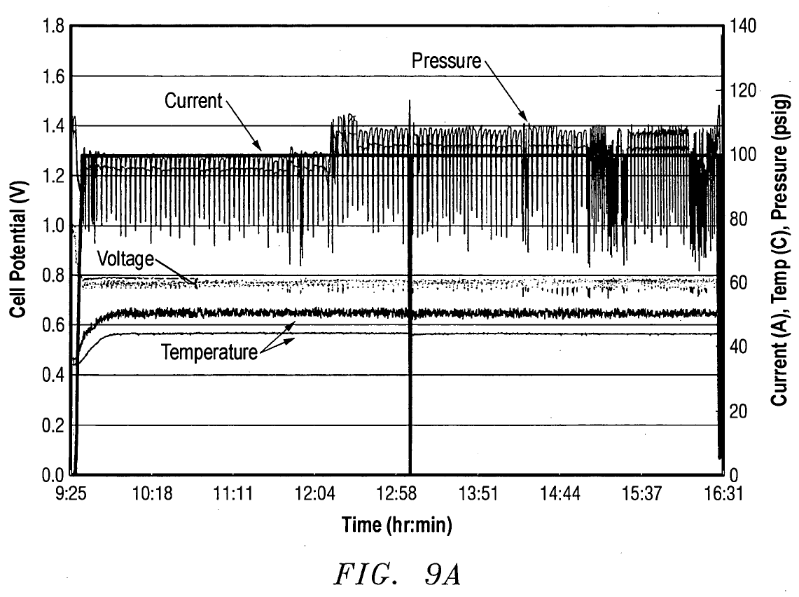

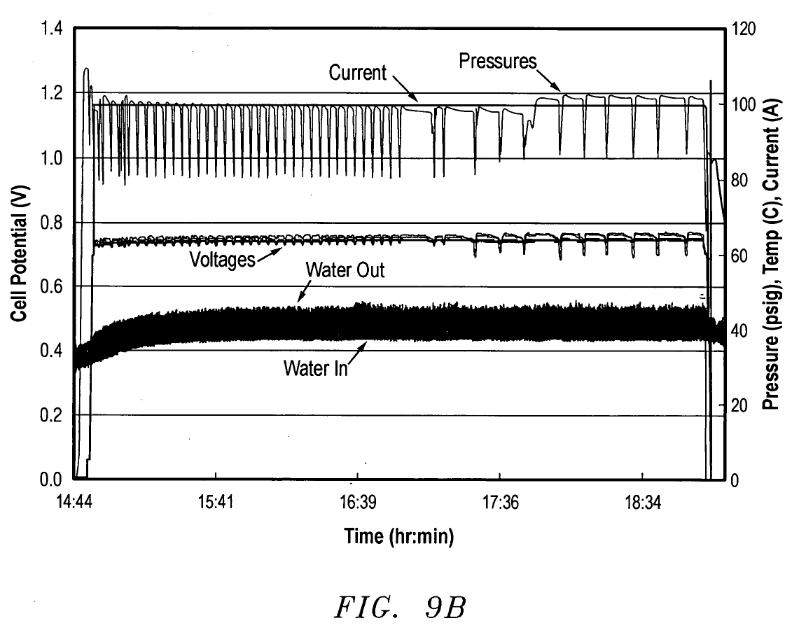

The results obtained from this operation are shown in FIGS. 9A and 9B. FIG. 9A shows the data collected during the operation of a twelve cell fuel cell stack 73. The voltages are shown to be stable during the test, showing only minor voltage swings that resulted from the pressure rising and falling. It should be noted that just after about 12 hours of operation, the operating pressure was raised from about 100 psig to about 110 psig to determine if there were any advantages to operating at the higher pressure. None were found. These results show that operation of a fuel cell stack as described does remove water from the cells and does not have an adverse affect on the fuel stack.

FIG. 9B shows the data collected during the operation of a separate four cell fuel cell stack. The first half of the graph illustrated in FIG. 9B, showing approximately the first 17 hours of operation, shows the system operating on a timed cycle as discussed above. The second half of the graph shows the mode operated by monitoring the drop in cell potential to trigger the pressure swing. In this mode, when the cell voltage dropped to about 0.7 volts, then the reactant inlet valves 82, 85 were opened until the pressure in the fuel cell stack 73 increased by 25 psi. Then the reactant inlet valves 82, 85 were closed until the cell potential again dropped to about 0.7 volts, at which time the cycle was repeated. Both modes show no degradation of potential during the testing. These results show that operation of a fuel cell stack as described does remove water from the cells and does not have an adverse affect on the fuel stack.

It should be understood from the foregoing description that various modifications and changes may be made in the preferred embodiment of the present invention without departing from its true spirit. It is intended that this description is for purposes of illustration only and should not be construed in a limiting sense. Only the language of the following claims should limit the scope of this invention.

What is claimed is:

1. An apparatus, comprising:
a reactant gas accumulator in fluid communication with a reactant gas manifold of a fuel cell.

2. The apparatus of claim 1, further comprising:
a reactant gas source in selective fluid communication with an inlet manifold of the fuel cell, wherein the inlet manifold and an outlet manifold are in fluid communication.

3. The apparatus of claim 2, wherein the inlet manifold and an outlet manifold are in fluid communication across an electrode of the fuel cell.

4. The apparatus of claim 2, further comprising:
a pressure regulator disposed between the reactant gas source and the inlet manifold.

5. The apparatus of claim 2, further comprising:
a pressure controller disposed between the reactant gas source and the inlet manifold, wherein the pressure controller is capable of varying the velocity of the reactant gas provided to the inlet manifold.

6. The apparatus of claim 2, further comprising:
a control valve disposed between the reactant gas source and the inlet manifold.

7. The apparatus of claim 6, wherein the valve is selected from a solenoid valve, pneumatically driven valve, a pilot operated valve, and a motor driven valve.

8. The apparatus of claim 2, further comprising:
a flow control valve disposed between the reactant gas source and the inlet manifold to control the flow rate of the reactant gas.

9. The apparatus of claim 1, further comprising:
a sensor capable of measuring an operating condition or parameter of the system.

10. The apparatus of claim 9, wherein the sensor measures pressure within the accumulator.

11. The apparatus of claim 9, wherein the sensor measures the flow rate of the reactant gas through the fuel cell.

12. The apparatus of claim 9, wherein the sensor measures the voltage of the fuel cell.

13. The apparatus of claim 9, wherein the sensor measures the state of fuel cell membrane hydration.

14. The apparatus of claim 9, wherein the sensor measures the liquid water presence in the fuel cell.

15. The apparatus of claim 9, wherein the sensor measures the humidity of the reactant gases within the fuel cell.

16. The apparatus of claim 1, further comprising:
a pressure sensor disposed in the accumulator.

17. The apparatus of claim 16 wherein the apparatus is provided with a means for determining the rate of pressure change within the accumulator.

18. The apparatus of claim 1 further including a pressure switch disposed in the accumulator.

19. The apparatus of claim 6, further comprising:
a controller in communication with the control valve, wherein the controller instructs the valve to provide the selective communication.

20. The apparatus of claim 19, wherein the controller provides a duty cycle wherein the control valve is open for a first time period and the control valve is closed for a second time period.

21. The apparatus of claim 19, wherein the controller provides a duty cycle based on one or more operating parameters of the system.

22. The apparatus of claim 1, further comprising:
a flow restriction device disposed in fluid communication between the reactant gas accumulator and the outlet manifold.

23. The apparatus of claim 2, further comprising:
a flow restriction device disposed in fluid communication at a position between the reactant gas source and the inlet manifold, between the reactant gas accumulator and the outlet manifold, or a combination thereof.

24. The apparatus of claim 1, wherein the reactant gas accumulator is also in fluid communication with an inlet manifold of the fuel cell.

25. The apparatus of claim 24, further comprising:
a first check valve allowing unidirectional flow from the reactant gas accumulator to the inlet manifold; and
a second check valve allowing unidirectional flow from the outlet manifold to the reactant gas accumulator.

26. The apparatus of claim 24, further comprising:
means for directing the reactant gas flow from the accumulator into the fuel cell in a direction selected from the same direction as the reactant gas flow from the reactant gas source into the fuel cell, the opposite direction as the reactant gas flow from the reactant gas source in the fuel cell, and combinations thereof.

27. The apparatus of claim 26, further comprising:
a valving arrangement positioned in the reactant gas conduits to alternate the direction of reactant gas flow into the fuel cell.

28. The apparatus of claim 27, wherein the valving arrangement is selected from a shuttle valve and a four-way flow reversing valve.

29. The apparatus of claim 26, further comprising:
means for alternating the direction of reactant gas flow into the fuel cell.

30. The apparatus of claim 1, wherein the accumulator includes a surplus water dump system.

31. The apparatus of claim 1, further comprising:
a valve controller in communication with a valve for providing the selective communication between the reactant gas source and the inlet manifold.

32. The apparatus of claim 31, wherein the valve controller includes a timer and operates the valve at specific time periods.

33. The apparatus of claim 2, wherein the pressure of the reactant gas to the fuel cell and the pressure of a second reactant gas source to the fuel cell are controlled to prevent a pressure differential that would damage the fuel cell.

34. The apparatus of claim 33, further comprising:
a second accumulator in fluid communication with a second reactant gas, wherein one of the reactant gas accumulators has a pressure regulator referenced to the pressure of the other reactant gas.

35. The apparatus of claim 2, further comprising:
an evacuation port in fluid communication with the accumulator for evacuating gas to remove inert species.

36. An apparatus, comprising:
a fuel cell having reactant gas distribution channels providing fluid communication between a reactant gas source and an accumulator vessel.

37. The apparatus of claim 36, wherein the reactant gas is selected from a fuel gas and an oxidant gas.

38. The apparatus of claim 36, further comprising:
a pressure regulator disposed between the reactant gas source and the reactant gas distribution system.

39. The apparatus of claim 36, further comprising:
a pressure controller disposed between the reactant gas source and the reactant gas distribution system, wherein the pressure controller is capable of varying the velocity of the reactant gas provided to the reactant gas distribution system.

40. The apparatus of claim 36, further comprising:
a control valve disposed between the reactant gas source and the reactant gas distribution system.

41. The apparatus of claim 36, further comprising:
a flow control valve disposed between the reactant gas source and the reactant gas distribution system to control the flow rate of the reactant gas in response to one or more parameter of the system.

42. The apparatus of claim 36, further comprising:
a sensor capable of measuring an operating condition selected from pressure within the accumulator, flow rate of the reactant gas through the fuel cell, voltage of the fuel cell, presence of liquid water in the fuel cell, reactant gas humidity, state of fuel cell membrane hydration, and combinations thereof.

43. The apparatus of claim 36, further comprising:
a pressure switch or sensor disposed in the accumulator.

44. The apparatus of claim 43, further comprising:
means for determining the rate of pressure change within the accumulator.

45. The apparatus of claim 40, further comprising:
a controller in communication with the solenoid valve, wherein the controller instructs the solenoid valve to provide selective fluid communication between the reactant gas source and the accumulator vessel.

46. The apparatus of claim 45, wherein the controller provides a duty cycle wherein the solenoid valve is open upon a first condition reaching a first setpoint and the solenoid valve is closed upon a second condition reaching a second setpoint.

47. The apparatus of claim 36, further comprising:
a flow restriction device disposed in fluid communication between the reactant gas accumulator and the reactant gas distribution system.

48. The apparatus of claim 36, further comprising:
a flow restriction device disposed in fluid communication at a position between the reactant gas source and the reactant gas distribution system, between the reactant gas distribution system and the reactant gas accumulator, or a combination thereof.

49. The apparatus of claim 36, wherein the reactant gas accumulator is in selective fluid communication with either an inlet end or outlet end of the reactant gas distribution system.

50. The apparatus of claim 49, further comprising:
a first check valve allowing only unidirectional flow from the reactant gas accumulator to the inlet end of the reactant gas distribution system; and
a second check valve allowing only unidirectional flow from the reactant gas distribution system to the reactant gas accumulator.

51. The apparatus of claim 49, further comprising:
means for directing the reactant gas flow from the accumulator to a water removal unit.

52. The apparatus of claim 49, further comprising:
means for directing the reactant gas flow from the accumulator into the fuel cell in a direction selected from the same direction as the reactant gas flow from the reactant gas source into the fuel cell, the opposite direction as the reactant gas flow from the reactant gas source in the fuel cell, and combinations thereof.

53. The apparatus of claim 51, further comprising:
shuttle valves positioned in communication with the inlet end and outlet end of the reactant gas distribution system to alternate the direction of reactant gas flow into the fuel cell.

54. The apparatus of claim 36, wherein the accumulator includes a surplus water removal system.

55. The apparatus of claim 36, further comprising:
a valve controller in communication with a valve for providing selective communication between the reactant gas source and the reactant gas distribution system.

56. The apparatus of claim 55, wherein the valve controller includes a timer and operates the valve at specific time periods.

57. The apparatus of claim 55, wherein the valve controller includes a pressure transducer and controls the rate of change of the pressure of the accumulator and fuel cell

58. The apparatus of claim 55, wherein the pressure of the reactant gas to the fuel cell and the pressure of a second reactant gas source to the fuel cell are controlled to prevent a pressure differential that would damage the fuel cell.

59. An apparatus, comprising:
an oxidant gas accumulator in fluid communication with an oxidant gas outlet manifold of a fuel cell; and
a fuel gas accumulator in fluid communication with a fuel gas outlet manifold of the fuel cell.

60. The apparatus of claim 59, wherein the oxidant gas comprises oxygen and the fuel gas comprises hydrogen.

61. The apparatus of claim 59, further comprising:
a pressure regulator disposed between an oxidant gas source and an oxidant gas inlet manifold; and
a pressure regulator disposed between a fuel gas source and a fuel gas inlet manifold.

62. A method, comprising:
purging water from a fuel cell with a reactant gas supply;
accumulating the reactant gas under pressure from the reactant gas supply; and
supplying the accumulated reactant gas to the fuel cell.

63. The method of claim 62, further comprising:
supplying the accumulated reactant gas to the fuel cell through an inlet manifold, an outlet manifold, or a combination thereof.

64. The method of claim 62, wherein the reactant gas is selected from an oxidant gas and a fuel gas.

65. The method of claim 62, further comprising:
accumulating a second reactant gas under pressure from a second reactant gas supply; and
supplying the accumulated second reactant gas to the fuel cell, wherein the reactant gases comprise an oxidant gas and a fuel gas.

66. The method of claim 62, further comprising:
regulating the pressure of the reactant gas.

67. The method of claim 62, further comprising:
regulating the flow rate of the reactant gas from the reactant gas supply.

68. The method of claim 62, further comprising:
receiving the purged water in the accumulator; and
removing the purges water from the accumulator.

69. The method of claim 62, further comprising:
repeating the steps of purging, accumulating and supplying.

70. The method of claim 69, wherein the steps of purging, accumulating and supplying are repeated under conditions selected from pressure within the accumulator, flow rate of the reactant gas through the fuel cell, voltage of the fuel cell, state of fuel cell membrane hydration, and combinations thereof.

71. A method, comprising:
supplying a reactant gas through a fuel cell at a flow rate sufficient to remove water; and then
returning the reactant gas to the fuel cell.

72. The method of claim 71, further comprising:
periodically switching between the steps of supplying and returning.

73. The method of claim 72, wherein the steps are periodically switched according to a duty cycle.

74. An apparatus, comprising:
a reactant gas source in fluid communication with an inlet and an outlet of a fuel cell; and
a shuttle valve to change direction of the reactant gas flow into the fuel cell.
